(19) United States
(12) Patent Application Publication
(10) Pub. No.: US 2026/0059557 A1
(43) Pub. Date: Feb. 26, 2026

(54) METHOD, DEVICE AND COMPUTER READABLE MEDIUM FOR SIDELINK COMMUNICATIONS

(71) Applicant: NEC Corporation, Tokyo (JP)

(72) Inventors: Jin YANG, Beijing (CN); Zhaobang MIAO, Beijing (CN); Gang WANG, Beijing (CN)

(73) Assignee: NEC Corporation, Tokyo (JP)

(21) Appl. No.: 19/105,390

(22) PCT Filed: Aug. 23, 2022
(86) PCT No.: PCT/CN2022/114354

§ 371 Date: Feb. 21, 2025

(51) Int. Cl. H04W 72/25; H04L 5/00

(52) U.S. Cl. CPC H04W 72/25; H04L 5/0094

(57) ABSTRACT

Embodiments of the present disclosure relate to methods, devices and computer readable media for sidelink communications. A method for sidelink communications comprises selecting, at a first terminal device, at least one Physical Sidelink Shared Channel (PSSCH) resource. Each of the at least one PSSCH resource is within a first type of sidelink resources or a second type of sidelink resources, and the first type of sidelink resources can be used for both a first sidelink associated with a first radio access technology (RAT) and a second sidelink associated with a second RAT, and the second type of sidelink resources can be used for the second sidelink. The method also comprises transmitting first sidelink data on the at least one PSSCH resource.

### TECHNICAL FIELD

Embodiments of the present disclosure generally relate to the field of telecommunication, and in particular, to a method, device and computer readable media for sidelink communications.

### BACKGROUND

There may be co-existence of a Long Term Evolution (LTE) sidelink and a New Radio (NR) sidelink. The co-existence of the two radio access technologies (RATs) may be based on LTE sidelink and NR sidelink framework. For the co-existence of LTE sidelink and NR sidelink, an NR sidelink terminal device may perform NR mode 2 sensing and resource selection procedure on shared resources, and an LTE sidelink terminal device may perform LTE mode 4 sensing and resource selection procedure on the shared resources. Co-existence of NR mode 2 sensing and resource selection procedure and LTE mode 4 sensing and resource selection procedure within shared resources is a key scenario.

### SUMMARY

In general, example embodiments of the present disclosure provide methods, devices and computer readable media for sidelink communications.

In a first aspect, there is provided a method for sidelink communications. The method comprises: selecting, at a first terminal device, at least one Physical Sidelink Shared Channel (PSSCH) resource, wherein each of the at least one PSSCH resource is within a first type of sidelink resources or a second type of sidelink resources, and the first type of sidelink resources can be used for both a first sidelink associated with a first radio access technology (RAT) and a second sidelink associated with a second RAT, and the second type of sidelink resources can be used for the second sidelink; and transmitting first sidelink data on the at least one PSSCH resource.

In a second aspect, there is provided a method for sidelink communications. The method comprises: determining assistant information at a second terminal device; and transmitting the assistant information to a first terminal device for determination of a first candidate resource set, wherein the first candidate resource set contains at least one candidate resource, and each of the candidate resource is contained within a first type of sidelink resources, the first type of sidelink resources can be used for both a first sidelink associated with a first RAT and a second sidelink associated with a second RAT.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a terminal device. The terminal device comprises a processor and a memory storing instructions. The memory and the instructions are configured, with the processor, to cause the terminal device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates an example of a timing resource allocation in a sidelink resource pool in accordance with some embodiments of the present disclosure:

FIG. 3 illustrates an example of a symbol allocation in a sidelink slot in accordance with some embodiments of the present disclosure:

FIG. 4 illustrates an example of a frequency resource allocation in a sidelink resource pool in accordance with some embodiments of the present disclosure:

FIG. 5 illustrates an example of sidelink channels in time domain in accordance with some embodiments of the present disclosure:

FIG. 6 illustrates an example of a symbol allocation in a sidelink subframe in accordance with other embodiments of the present disclosure:

FIG. 7 illustrates a flowchart of an example method in accordance with some embodiments of the present disclosure:

FIGS. 8 and 9 illustrate a signaling chart illustrating a process for determining the candidate resource set in accordance with some implementations of the present disclosure, respectively:

FIGS. 10 to 14 illustrate a signaling chart illustrating a process for selecting at least one PSSCH resource in accordance with some implementations of the present disclosure, respectively:

FIG. 15 illustrates a flowchart of an example method in accordance with some embodiments of the present disclosure; and

FIG. 16 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices. Internet of Everything (IoE) devices, machine type communication (MTC) devices, device on vehicle for V2X communication where X means pedestrian, vehicle, or infrastructure/network, devices for Integrated Access and Backhaul (IAB). Small Data Transmission (SDT), mobility. Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR). Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical. V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges. e.g. FR1 (410 MHz-7125 MHz). FR2 (24.25 GHz to 71 GHz), frequency band larger than 100 GHz as well as Tera Hertz. (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As used herein, the singular forms ‘a’, ‘an’ and ‘the’ are intended to include the plural forms as well, unless the context clearly indicates otherwise. The term ‘includes and its variants are to be read as open terms that mean ‘includes, but is not limited to.’ The term ‘based on’ is to be read as ‘at least in part based on.’ The term ‘some embodiments’ and ‘an embodiment are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

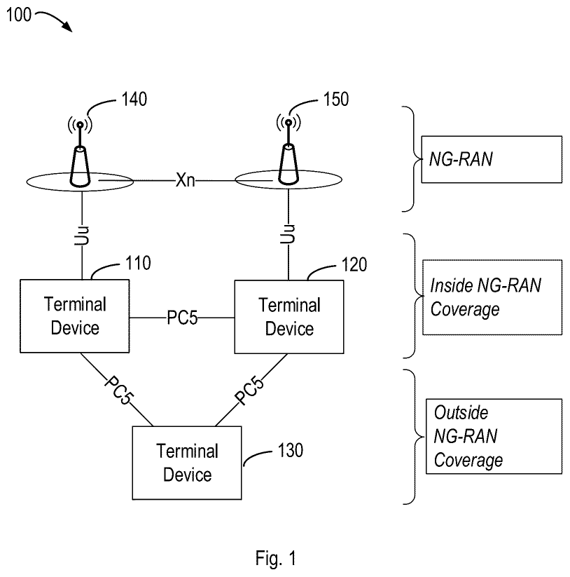

FIG. 1 illustrates a schematic diagram of an example communication network 100 in which embodiments of the present disclosure can be implemented. As shown in FIG. 1, the communication network 100 may include a first terminal device 110, a second terminal device 120, a third terminal device 130, network devices 140 and 150. The network devices 140 and 150 may communicate with the first terminal device 110, the second terminal device 120 and the third terminal device 130 via respective wireless communication channels.

In some embodiments, each of the terminal devices 110, 120 and 130 as well as the network devices 140 and 150 may use a first radio access technology (RAT) or a second RAT.

In some embodiments, the first RAT may be Long Term Evolution (LTE), and the second RAT may be NR.

In embodiments where the terminal devices 110, 120 and 130 as well as the network devices 140 and 150 use LTE, the terminal devices 110, 120 and 130 may be referred to as LTE terminal devices 110, 120 and 130, and the network devices 140 and 150 may be referred to as gNBs.

In embodiments where the terminal devices 110, 120 and 130 as well as the network devices 140 and 150 use NR, the terminal devices 110, 120 and 130 may be referred to as NR terminal devices 110, 120 and 130, and the network devices 140 and 150 may be referred to as eNBs.

It is to be understood that the number of devices in FIG. 1 is given for the purpose of illustration without suggesting any limitations to the present disclosure. The communication network 100 may include any suitable number of network devices and/or terminal devices adapted for implementing embodiments of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the first terminal device 110, the second terminal device 120 and the third terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the first terminal device 110) to a target terminal device (such as the second terminal device 120) through the Unified Air Interface, e.g., PC5 interface, (i.e., sidelink transmissions), as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

For sidelink communications, a terminal device uses resources in sidelink resource pools to transmit or receive signals. The sidelink resource pools include resources in time domain and frequency domain, which are dedicated resources of the sidelink communication, or shared by the sidelink communication and a cellular link. For sidelink communications, two modes of resource assignment may be used for sidelink, including network device schedules sidelink resources for terminal devices to perform sidelink signal transmission, named as mode 1 resource scheme in NR sidelink or mode 3 resource scheme in LTE sidelink, and terminal device selects sidelink resources by itself to perform sidelink signal transmission, named as mode 2 resource scheme in NR sidelink or mode 4 resource scheme in LTE sidelink.

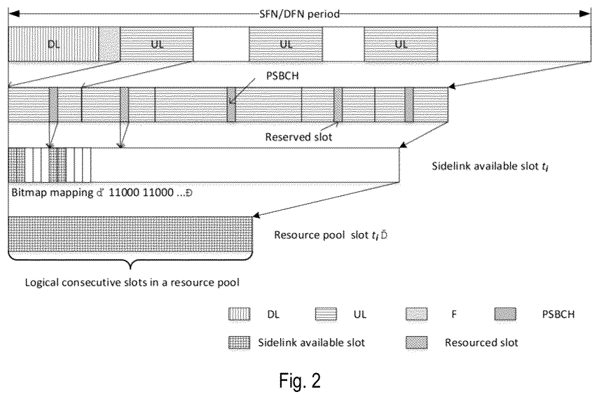

FIG. 2 illustrates an example of a timing resource allocation in a sidelink resource pool in accordance with some embodiments of the present disclosure. In some embodiments, the sidelink resource pool may comprise an NR sidelink resource pool. In such embodiments, the sidelink resource pool may be defined within a sidelink bandwidth part (BWP). The first terminal device 110, the second terminal device 120 and the third terminal device 130 may use uplink (UL) resources for sidelink communications. More than one sidelink resource pools may be configured for one of the first terminal device 110, the second terminal device 120 and the third terminal device 130. A dedicated resource pool may be used for mode 1 resource scheme or mode 2 resource scheme, short for mode 1 resource pool or mode 2 resource pool. For LTE sidelink, a dedicated resource pool may be used for mode 3 resource scheme or mode 4 resource scheme, short for mode 3 resource pool or mode 4 resource pool. Resources within the sidelink resource pool may comprise Physical Sidelink Control Channel (PSCCH) resources, Physical Sidelink Shared Channel (PSSCH) resources and physical sidelink feedback channel (PSFCH) resources. A bitmap may be used to indicate which UL slots are configured as sidelink slots. A length of the bitmap may be in a range of 10 to 160.

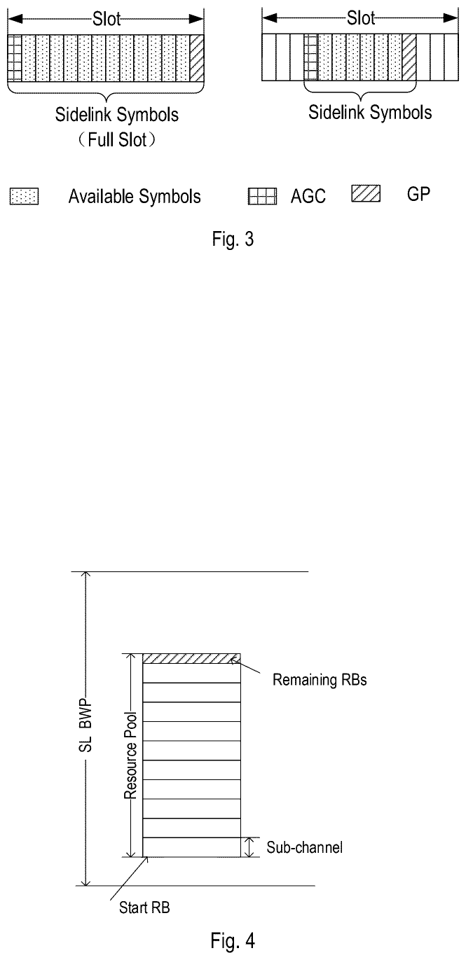

FIG. 3 illustrates an example of a symbol allocation in a sidelink slot in accordance with some embodiments of the present disclosure. In the sidelink resource pool which may contain multiple slots and resource blocks (RBs), and all or part of the symbols in a slot can be used for sidelink transmission. Within the resource pool, among all the symbols configured for sidelink in each slot, the first symbol (i.e., the start symbol) is used as the automatic gain control (AGC) symbol, and the last symbol used as a guard period (GP) symbol. AGC symbols and GP symbols can be considered as fixed overheads in sidelink resource. In the description of the following embodiments, AGC symbols and GP symbols are included in the sidelink symbols which are indicated by the sidelink channel resource configuration, and AGC symbols carry redundancy sidelink information while GP symbols are not used for carrying sidelink information, as shown in FIG. 3.

The first terminal device 110, the second terminal device 120 and the third terminal device 130 may use sidelink channels to transmit sidelink signaling or information. The sidelink channels include at least one of the following: a PSCCH resource which is used for carrying sidelink control information (SCI), a PSSCH resource which is used for carrying sidelink data service information, a PSFCH resource which is used for carrying sidelink Hybrid Automatic Repeat Request (HARQ) feedback information, a physical sidelink broadcast channel (PSBCH) resource which is used for carrying sidelink broadcast information, and a physical sidelink discovery channel (PSDCH) resource which is used for carrying a sidelink discovery signal.

FIG. 4 illustrates an example of a frequency resource allocation in a sidelink resource pool in accordance with some embodiments of the present disclosure. In some embodiments, the sidelink resource pool may be an NR sidelink resource pool. As shown in FIG. 4, the sidelink resource pool may be configured within a SL Bandwidth Part (Sidelink BWP). A resource pool configuration may comprise sl-StartRB-Subchannel and sl-RB-Number. The sl-StartRB-Subchannel may indicate the lowest Resource Block (RB) of the resource pool. The lowest RB is also referred to as a start RB. The sl-RB-Number may indicate the total number of RBs of the resource pool.

RBs in the resource pool may be divided into consecutive sub-channels. Sub-channel is a frequency resource unit of PSSCH. Each sub-channel contains consecutive RBs. The terminal devices 110, 120 and 130 may use one or more consecutive sub-channels as a PSSCH resource to transmit sidelink data. A sub-channel configuration of the resource pool may comprise sl-SubchannelSize which indicates the number of RBs contained in one sub-channel. The SubchannelSize may be equal to 10, 12, 15, 20, 25, 50, 75 or 100.

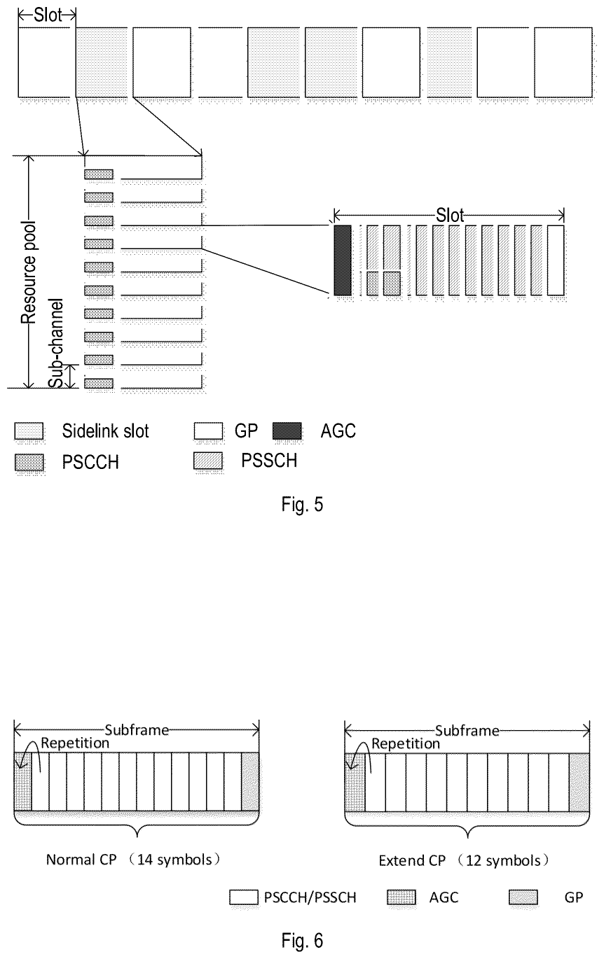

FIG. 5 illustrates an example of sidelink channels in time domain in accordance with some embodiments of the present disclosure. In the example of FIG. 5, the sidelink channels comprise PSCCH and PSSCH. PSCCH may carry SCI format 1. One PSCCH may be defined within each sub-channel. Each PSCCH resource may include t consecutive symbols in time domain and k consecutive RBs in frequency domain. The t symbols start from the first symbol in the available symbols in the time domain, where t=2 or 3. The k RBs start from the first RB in the corresponding sub-channel, where k=10, 12, 15, 20, or 25. PSSCH may carry SCI format 2A/2B and sidelink data PSSCH uses sub-channel as a frequency unit. The terminal devices 110, 120 and 130 may use one or more consecutive sub-channels as a PSSCH resource to transmit sidelink data.

Similar to the NR sidelink resource pool, within an LTE sidelink resource pool, the first terminal device 110, the second terminal device 120 or the third terminal device 130 may use uplink (UL) resources for sidelink communications. More than one sidelink resource pools may be configured for the first terminal device 110, the second terminal device 120 or the third terminal device 130. Resources within the LTE sidelink resource pool may comprise a PSCCH resource pool and a PSSCH resource pool. A bitmap may be used to indicate which UL subframes are configured as sidelink subframes.

FIG. 6 illustrates an example of a symbol allocation in a sidelink subframe in accordance with other embodiments of the present disclosure. In some embodiments, sidelink subframes in FIG. 6 may be LTE sidelink subframes. As shown in FIG. 6, all symbols in a subframe are used as sidelink resource. In a subframe, the first symbol is used as AGC and the last symbol is used as GP.

LTE sidelink channels may comprise PSCCH and PSSCH. PSCCH may carry SCI format 1. One PSCCH is associated with one sub-channel. Each PSCCH resource has a fixed size. For example, each PSCCH resource may comprise two consecutive PRBs and all symbols in a sidelink subframe. PSSCH may carry sidelink data and use sub-channel as frequency unit. The first terminal device 110, the second terminal device 120 or the third terminal device 130 may use one or more consecutive sub-channels as PSSCH resource to transmit sidelink data. Relationship between PSCCH and sub-channel may be one-to-one mapping.

As mentioned above, for the co-existence of LTE sidelink and NR sidelink, an NR sidelink terminal device may perform NR mode 2 sensing and resource selection procedure on shared resources, and an LTE sidelink terminal device may perform LTE mode 4 sensing and resource selection procedure on the shared resources. Co-existence of NR mode 2 sensing and resource selection procedure and LTE mode 4 sensing and resource selection procedure within shared resources is a key scenario. In such a scenario, the NR sidelink terminal device may consider sensing result and resource reservation information of LTE sidelink to determine its own sidelink transmission resources.

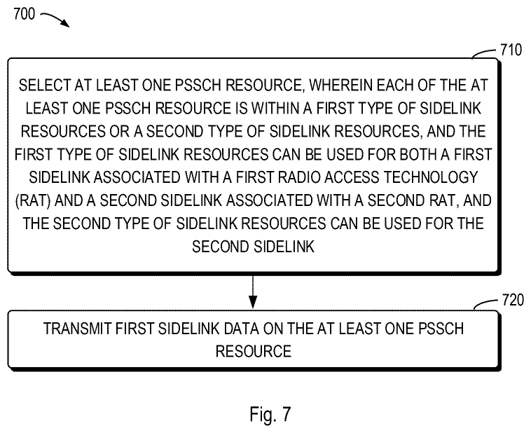

Embodiments of the present disclosure provide a solution for sidelink communications so as to solve the above problems and one or more of other potential problems. According to the solution, a first terminal device selects at least one PSSCH resource and transmits first sidelink data on the at least one PSSCH resource. Each of the at least one PSSCH resource is within a first type of sidelink resources or a second type of sidelink resources. The first type of sidelink resources can be used for both a first sidelink associated with a first RAT and a second sidelink associated with a second RAT. The second type of sidelink resources can be used for the second sidelink. Hereinafter, principle of the present disclosure will be described with reference to FIGS. 7 to 15.

FIG. 7 illustrates a flowchart of an example method in accordance with some embodiments of the present disclosure. In some embodiments, the method 700 can be implemented at a terminal device, such as one of the first terminal device 110, the second terminal device 120 and the third terminal device 130 as shown in FIG. 1. For the purpose of discussion, the method 700 will be described with reference to FIG. 1 as performed by the first terminal device 110 without loss of generality:

At block 710, the first terminal device 110 selects at least one PSSCH resource. Each of the at least one PSSCH resource is within a first type of sidelink resources or a second type of sidelink resources. The first type of sidelink resources can be used for both a first sidelink associated with a first RAT and a second sidelink associated with a second RAT. The second type of sidelink resources can be used for the second sidelink.

At block 720, the first terminal device 110 transmits first sidelink data on the at least one PSSCH resource.

With the method 700, co-existence of NR mode 2 sensing and resource selection procedure and LTE mode 4 sensing and resource selection procedure within shared resources may be achieved.

In some embodiments, the first type of sidelink resources may be overlapping resources of a first sidelink resource pool for the first sidelink and a second sidelink resource pool for the second sidelink. In other words, the first type of sidelink resources may be shared resources between the first sidelink resource pool and the second sidelink resource pool. In the present disclosure, terms “overlapping” and “shared” may be used interchangeably:

On the other hand, dedicated resources may be used for the first sidelink or the second sidelink and may be non-overlapping with each other. Thus, terms “non-overlapping” and “dedicated” may be used interchangeably. In some embodiments, the second type of sidelink resources may be non-overlapping or dedicated resources for the second sidelink.

In some embodiments, the first RAT may be LTE and the second RAT may be NR. In such embodiments, the first sidelink may be a sidelink associated with LTE (also referred to as LTE sidelink), and the second sidelink may be a sidelink associated with NR (also referred to as NR sidelink). In addition, a first sidelink resource pool may be a sidelink resource pool associated with LTE (also referred to as LTE sidelink resource pool), and a second sidelink resource pool may be a sidelink resource pool associated with NR (also referred to as NR sidelink resource pool).

Hereinafter, some embodiments of the present disclosure will be described by taking LTE sidelink and NR sidelink for example. It shall be understood that the solution of the present disclosure may be applied to other RATs than LTE and NR.

### I. Configuration or Pre-Configuration of the First Type of Sidelink Resources.

In some embodiments, the first terminal device 110 may select the at least one PSSCH resource based on a configuration or pre-configuration of the first type of sidelink resources.

In some embodiments, the configuration or pre-configuration of the first type of sidelink resources may comprise:
a first indication indicating whether all resources in a sidelink resource pool are the first type of sidelink resources or not, or
a second indication indicating whether the first terminal device 110 can select the at least one PSSCH resource within the first type of sidelink resources or not.

In such embodiments, the configuration or pre-configuration of the first type of sidelink resources may be provided as below:

| - | SL-LTE-NR-Coex: | | |
|---|---|---|---|
| | • | SL-Coex | ENUMERATED {enabled, disabled} |

where SL-LTE-NR-Coex represents the configuration or pre-configuration of the first type of sidelink resources, SL-Coex represents the first indication or the second indication.

In embodiments where SL-Coex represents the first indication, if SL-Coex is configured as enabled for a resource pool, it indicates that all resources in the sidelink resource pool are the first type of sidelink resources. If SL-Coex is configured as disabled for a resource pool, it indicates that resources in the sidelink resource pool are not the first type of sidelink resources. The sidelink resource pool may be a sidelink resource pool of the second sidelink or a sidelink resource pool of the first sidelink. For example, the sidelink resource pool may be an NR sidelink resource pool or LTE sidelink resource pool.

In embodiments where SL-Coex represents the second indication, if SL-Coex is configured as enabled for the first terminal device 110, it indicates that the first terminal device 110 can select the at least one PSSCH resource within the first type of sidelink resources. If SL-Coex is configured as disabled for the first terminal device 110, it indicates that the first terminal device 110 cannot select the at least one PSSCH resource within the first type of sidelink resources.

In some embodiments, the configuration or pre-configuration of the first type of sidelink resources may comprise at least one of the following:
a first Channel Busy Ratio (CBR) threshold for a first sidelink resource pool of the first sidelink, or
a first Channel Occupancy Ratio (CR) threshold for the first sidelink resource pool.

In such embodiments, the configuration or pre-configuration of the first type of sidelink resources may be provided as below:

| | |
|---|---|
| - | SL-LTE-NR-Coex: |

| | | |
|---|---|---|
| • | sl-CBRThreshold-CoexLTE | INTEGER(0..100) |
| • | sl-CRThreshold-CoexLTE | INTEGER(0..10000) |

where SL-LTE-NR-Coex represents the configuration or pre-configuration of the first type of sidelink resources, sl-CBRThreshold-CoexLTE represents the first CBR threshold for an LTE sidelink resource pool, sl-CRThreshold-CoexLTE represents the first CR threshold for the LTE sidelink resource pool. Value 0 of the first CBR threshold corresponds to 0, value 1 of the first CBR threshold corresponds to 0.01, value 2 of the first CBR threshold corresponds to 0.02, and so on. Value 0 of the first CR threshold corresponds to 0, value 1 of the first CR threshold corresponds to 0.0001, value 2 of the first CR threshold corresponds to 0.0002, and so on (i.e., in steps of 0.0001) until value 10000, which corresponds to 1.

In some embodiments, the configuration or pre-configuration of the first type of sidelink resources (SL-LTE-NR-Coex) may comprise at least one of sl-CBRThreshold-CoexLTE and sl-CRThreshold-CoexLTE.

In some embodiments, if a CBR of the first sidelink resource pool is equal to or higher than the first CBR threshold, the first terminal device 110 cannot select the at least one PSSCH resource within the first type of sidelink resources. If a CBR of the first sidelink resource pool is equal to or lower than the first CBR threshold, the first terminal device 110 can select the at least one PSSCH resource within the first type of sidelink resources.

In some embodiments, if a CR of the first sidelink resource pool is equal to or higher than the first CR threshold, the first terminal device 110 cannot select the at least one PSSCH resource within the first type of sidelink resources. If a CR of the first sidelink resource pool is equal to or lower than the first CR threshold, the first terminal device 110 can select the at least one PSSCH resource within the first type of sidelink resources.

In some embodiments, the configuration or pre-configuration of the first type of sidelink resources may comprise at least one of the following:
a second CBR threshold for a second sidelink resource pool of the second sidelink, or
a second CR threshold for the second sidelink resource pool.

In such embodiments, the configuration or pre-configuration of the first type of sidelink resources may be provided as below:

| | |
|---|---|
| - | SL-LTE-NR-Coex: |

| | | |
|---|---|---|
| • | sl-CBRThreshold-CoexNR | INTEGER(0..100) |
| • | sl-CRThreshold-CoexNR | INTEGER(0..10000) |

where SL-LTE-NR-Coex represents the configuration or pre-configuration of the first type of sidelink resources, sl-CBRThreshold-CoexNR represents the second CBR threshold for an NR sidelink resource pool, sl-CRThreshold-CoexNR represents the second CR threshold for the NR sidelink resource pool. Value 0 of the second CBR threshold corresponds to 0, value 1 of the second CBR threshold corresponds to 0.01, value 2 of the second CBR threshold corresponds to 0.02, and so on. Value 0 of the second CR threshold corresponds to 0, value 1 of the second CR threshold corresponds to 0.0001, value 2 of the second CR threshold corresponds to 0.0002, and so on (i.e., in steps of 0.0001) until value 10000, which corresponds to 1.

In some embodiments, the configuration or pre-configuration of the first type of sidelink resources (SL-LTE-NR-Coex) may comprise at least one of sl-CBRThreshold-CoexNR and sl-CRThreshold-CoexNR.

In some embodiments, if a CBR of the second sidelink resource pool is equal to or higher than the second CBR threshold, the first terminal device 110 can select the at least one PSSCH resource within the first type of sidelink resources. If a CBR of the second sidelink resource pool is equal to or lower than the second CBR threshold, the first terminal device 110 cannot select the at least one PSSCH resource within the first type of sidelink resources.

In some embodiments, if a CR of the second sidelink resource pool is equal to or higher than the second CR threshold, the first terminal device 110 can select the at least one PSSCH resource within the first type of sidelink resources. If a CR of the second sidelink resource pool is equal to or lower than the second CR threshold, the first terminal device 110 cannot select the at least one PSSCH resource within the first type of sidelink resources.

In some embodiments, a CBR measured in slot n may be determined as a portion of sub-channels in a sidelink resource pool whose SL Received Signal Strength Indicator (RSSI) measured by the first terminal device 110 exceed a (pre-) configured threshold sensed over a CBR measurement window [n−a, n−1], wherein a is equal to 100 or 100·2^{μ} slots, according to higher layer parameter sl-Time Window SizeCBR.

In some embodiments, a CR evaluated at slot n may be determined as a total number of sub-channels used for transmissions of the first terminal device 110 in slots [n−a, n−1] and granted in slots [n, n+b] divided by the total number of configured sub-channels in the transmission pool over [n−a, n+b].

In some embodiments, at least one of the first CBR threshold, the first CR threshold, the second CBR threshold and the second CR threshold may be configured per priority of sidelink data.

In such embodiments, the configuration or pre-configuration of the first type of sidelink resources may be provided as below:

| - | SL-LTE-NR-Coexlist: SEQUENCE (SIZE (1..8)) OF | |
|---|---|---|
| | SL-LTE-NR-Coex | |
| | • | SL-LTE-NR-Coex: |

| | | |
|---|---|---|
| [symbol] | sl-PriorityThreshold | INTEGER (1..8) |
| [symbol] | sl-CBRThreshold-Coex | INTEGER(0..100) |
| [symbol] | sl-CRThreshold-Coex | INTEGER(0..10000) |

where SL-LTE-NR-Coexlist represents a CR/CBR threshold list configured per priority for a sidelink resource pool, sl-Priority Threshold represents a priority threshold of sidelink data, sl-CBRThreshold-Coex represents the first CBR threshold associated with the sl-Priority Threshold for the LTE sidelink resource pool or the second CBR threshold associated with the sl-PriorityThreshold for an NR sidelink resource pool, sl-CRThreshold-Coex represents the first CR threshold associated with the sl-Priority Threshold for the LTE sidelink resource pool or the second CR threshold associated with the sl-Priority Threshold for an NR sidelink resource pool. For each priority (of data on PSSCH), associated CR/CBR thresholds are configured for mode 2 procedure associated with shared resources.

In some embodiments, SL-LTE-NR-Coexlist may comprise at least one of sl-CBRThreshold-Coex and sl-CRThreshold-Coex.

In some embodiments, the configuration or pre-configuration of the first type of sidelink resources comprises a priority threshold.

In such embodiments, the configuration or pre-configuration of the first type of sidelink resources may be provided as below:

| | |
|---|---|
| - | SL-LTE-NR-Coex: |

| | | |
|---|---|---|
| • | SL-Coex-PriorityThreshold | INTEGER (1..8) |

where SL-LTE-NR-Coex represents the configuration or pre-configuration of the first type of sidelink resources, SL-Coex-Priority Threshold represents the priority threshold.

In some embodiments, the priority threshold (SL-Coex-Priority Threshold) may be used to determine whether the shared resources can be used for transmission of the first sidelink data. If a first priority of the first sidelink data is equal to or higher than the priority threshold, the first terminal device 110 can select the at least one PSSCH resource within the first type of sidelink resources. Alternatively, if a first priority of the first sidelink data is equal to or lower than the priority threshold, the first terminal device 110 can select the at least one PSSCH resource within the first type of sidelink resources.

In some embodiments, the configuration or pre-configuration of the first type of sidelink resources may comprise a Reference Signal Receiving Power (RSRP) threshold list for the first type of sidelink resources.

In such embodiments, the configuration or pre-configuration of the first type of sidelink resources may be provided as below:

| - | SL-LTE-NR-Coex: | | |
|---|---|---|---|
| | • | sl-Thres-RSRP-List | SEQUENCE (SIZE (64)) OF |
| | | SL-Thres-RSRP-r16 | |

| | | |
|---|---|---|
| [symbol] | SL-Thres-RSRP-r16 | INTEGER (0..66) |

where SL-LTE-NR-Coex represents the configuration or pre-configuration of the first type of sidelink resources, sl-Thres-RSRP-List represents the RSRP threshold list for the first type of sidelink resources which comprises 64 RSRP thresholds, and SL-Thres-RSRP-r16 represents an RSRP threshold in the list. The RSRP threshold should be selected based on the priority in the decoded SCI and the priority in the SCI to be transmitted. A resource is excluded if it is indicated or reserved by decoded SCI and PSSCH/PSCCH RSRP in the associated data resource is above or equal to the RSRP threshold.

By using at least one threshold as described above, the shared resources usage can be managed, the potential resource conflicts may be controlled and resource efficiency may be improved.

### II. Selection of the at Least One PSSCH Resource

In some embodiments, the first terminal device 110 may determine a candidate resource set based on assistant information and select the at least one PSSCH resource within the candidate resource set. Hereinafter, the candidate resource set may be represented by SA.

In such embodiments, the candidate resource set may comprise at least one of a first candidate resource set, or a second candidate resource set. For example, the candidate resource set may comprise the first candidate resource set, the second candidate resource set or a combination of the first and second candidate resource sets.

In some embodiments, at least one candidate resource is contained in the first candidate resource set, and each of the at least one candidate resource contained in the first candidate resource set is contained within the first type of sidelink resources. Hereinafter, the first candidate resource set may be represented by SA-LTE.

In some embodiments, at least one candidate resource is contained in the second candidate resource set, and each of the at least one candidate resource contained in the second the candidate resource set is contained within the second type of sidelink resources. Hereinafter, the second candidate resource set may be represented by SA-NR.

In some embodiments, the first terminal device 110 may comprise a first module of the first sidelink and a second module of the second sidelink. In such embodiments, the first terminal device 110 may be referred to as Type A sidelink terminal device 110 or Type A sidelink UE 110.

In embodiments where the first sidelink is LTE sidelink and the second sidelink is NR sidelink, the first module may be an LTE sidelink module and second module may be an NR sidelink module. For a UE, a MAC entity-NR may be associated to the NR sidelink module, and a MAC entity-LTE may be associated to the LTE sidelink module.

Hereinafter, some examples of determining the candidate resource set SA will be described by taking LTE sidelink and NR sidelink for example. It shall be understood that the solution of the present disclosure may be applied to other RATs than LTE and NR.

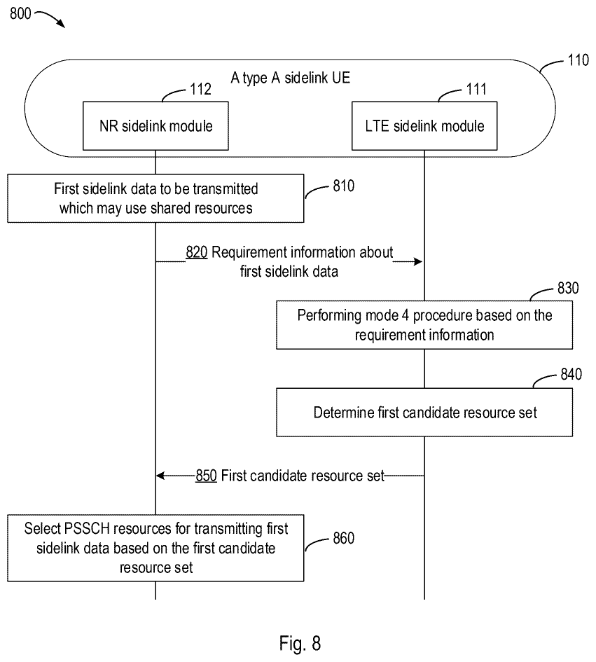

In some embodiments, the candidate resource set SA may be determined by the first module (for example, the LTE sidelink module) of the first terminal device 110. This will be described with reference to FIG. 8.

FIG. 8 illustrates a signaling chart illustrating a process 800 for determining the candidate resource set S_{A} in accordance with some implementations of the present disclosure. For the purpose of discussion, the process 800 will be described with reference to FIG. 1. The process 800 may involve the first terminal device 110 as illustrated in FIG. 1. Although the process 800 will be described in the communication network 100 of FIG. 1, this process may be likewise applied to other communication scenarios.

In the process 800, the first terminal device 110 comprises the first module of the first sidelink (for example, an LTE sidelink module 111) and the second module of the second sidelink (for example, an NR sidelink module 112). In this regard, the first terminal device 110 is also referred to as Type A sidelink UE 110. The LTE sidelink module 111 determines the first candidate resource set S_{A-LTE}. The NR sidelink module 112 selects the at least one PSSCH resource for transmitting the first sidelink data based on the first candidate resource set S_{A-LTE}.

As shown in FIG. 8, the NR sidelink module 112 determines 810 the first sidelink data to be transmitted which may use the first type of sidelink resources (for example, shared resources).

In turn, the NR sidelink module 112 provides a request for the assistant information to the LTE sidelink module 111.

In some embodiments, the NR sidelink module 112 may provide the request for the assistant information by providing 820 requirement information about the first sidelink data.

In some embodiments, the requirement information about the first sidelink data may comprise at least one of the following:
an identity of a first sidelink resource pool of the first sidelink,
an identity of a second sidelink resource pool of the second sidelink,
an identity of the first type of sidelink resources,
a size of a transmission block associated with the first sidelink data,
a size of a Medium Access Control Packet Data Unit (MAC PDU) associated with the first sidelink data,
the number of sub-channels or resource blocks to be selected for the transmission of the first sidelink data,
a priority of the first sidelink data,
a period of the first sidelink data,
a resource selection window for the at least one PSSCH resource, or
the number of retransmissions for the first sidelink data.

Upon receiving the request for the assistant information, the LTE sidelink module 111 performs 830 an LTE sidelink mode 4 sensing and resource selection procedure based on the requirement information. In turn, the LTE sidelink module 111 determines 840 the first candidate resource set S_{A-LTE} within the first type of sidelink resources.

In some embodiments, in order to determine the first candidate resource set S_{A-LTE}, the LTE sidelink module 111 may exclude resources which are not contained within the first type of sidelink resources from an initial candidate resource set within the first sidelink resource pool. For example, for the case that an LTE sidelink resource pool which is partially overlapped with an NR sidelink resource pool, the LTE sidelink module 111 may perform the mode 4 procedure within the LTE sidelink resource pool and exclude non-overlapping resources from the first candidate resource set S_{A-LTE}.

In other embodiments, for the case that an LTE sidelink resource pool which is full overlapped with an NR sidelink resource pool, i.e., a shared resource pool, the LTE sidelink module 111 may perform the mode 4 procedure within the LTE sidelink resource pool to determine the first candidate resource set S_{A-LTE} within the first type of sidelink resources.

In still other embodiments, for the case that an LTE sidelink resource pool which is partially overlapped with an NR sidelink resource pool, the LTE sidelink module 111 may perform the mode 4 procedure within the overlapped resources, i.e., setting an initial candidate resource set within the shared part of resources.

Upon determining the first candidate resource set S_{A-LTE}, the LTE sidelink module 111 provides 850 the first candidate resource set S_{A-LTE} to the NR sidelink module 112.

In embodiments where the NR sidelink module 112 provides to the LTE sidelink module 111 the request for the assistant information by providing the requirement information about the first sidelink data, the LTE sidelink module 111 provides to the NR sidelink module 112 the first candidate resource set S_{A-LTE} as the assistant information.

Upon receiving the first candidate resource set S_{A-LTE}, the NR sidelink module 112 selects 860 the at least one PSSCH resource based on the first candidate resource set S_{A-LTE}. For example, the NR sidelink module 112 may select the at least one PSSCH

resource within the S_{A-LTE}, i.e. no NR sidelink mode 2 sensing and resource selection procedure on NR sidelink is needed, and the selected at least one PSSCH resource is a shared resource.

For another example, the NR sidelink module 112 may perform an NR sidelink mode 2 sensing and resource selection procedure on NR sidelink to determine the second candidate resource set S_{A-NR}.

The NR mode 2 sensing and resource selection procedure may comprise one of the following: full sensing procedure, partial sensing procedure, or random selection procedure. In the full sensing procedure, the first terminal device 110 may set an initial candidate resource set as a full set. In turn, the first terminal device 110 may determine the second candidate resource set S_{A-NR} by excluding unavailable resources from the initial candidate resource set.

The NR sidelink module 112 may combine the first candidate resource set S_{A-LTE} and the second candidate resource set S_{A-NR} so as to determine the candidate resource set S_{A}. In turn, the NR sidelink module 112 may select the at least one PSSCH resource for data transmission within the candidate resource set S_{A}. In this manner, the selected at least one PSSCH resource for data transmission may be within S_{A-LTE} or within S_{A-NR}.

The process 800 provides an enhanced legacy LTE mode 4 or NR mode 2 procedure to determine resources for sidelink transmission in co-existence scenarios with limited impact and enhancement for NR SL module.

With the process 800, potential resource confliction between LTE and NR sidelink transmissions may be avoided.

In addition, combined with the configuration or pre-configuration of the first type of sidelink resources as described in Section I, the process 800 may provide flexibility and configurability for SL co-existence.

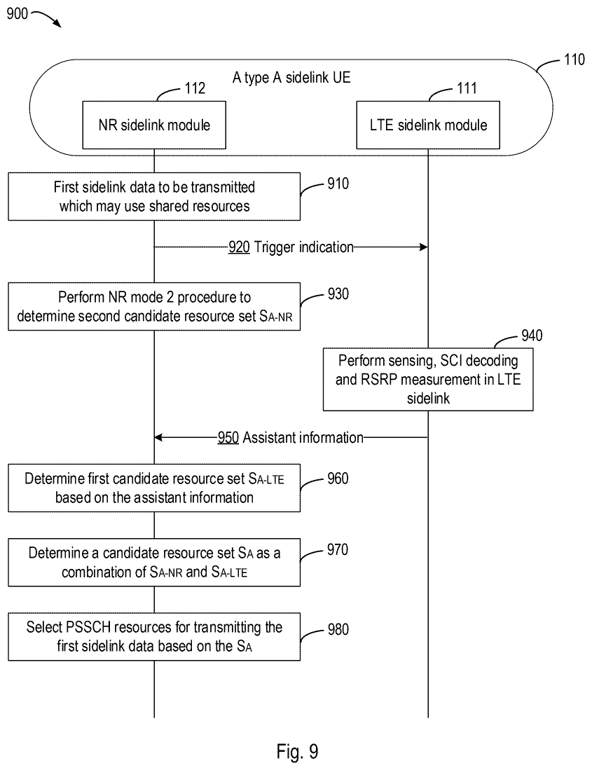

In some embodiments, the candidate resource set S_{A} may be determined by the second module (for example, the NR sidelink module) of the first terminal device 110. This will be described with reference to FIG. 9.

FIG. 9 illustrates a signaling chart illustrating a process 900 for determining the candidate resource set S_{A} in accordance with some other implementations of the present disclosure. For the purpose of discussion, the process 900 will be described with reference to FIG. 1. The process 900 may involve the first terminal device 110 as illustrated in FIG. 1. Although the process 900 will be described in the communication network 100 of FIG. 1, this process may be likewise applied to other communication scenarios.

Similar to the process 800, in the process 900, the first terminal device 110 comprises the first module of the first sidelink (for example, an LTE sidelink module 111) and the second module of the second sidelink (for example, an NR sidelink module 112).

The process 900 is different from the process 800 in that the first terminal device 110 does not determine the first candidate resource set S_{A-LTE}. Instead, the first terminal device 110 determines the assistant information and provides the assistant information to the NR sidelink module 112. The NR sidelink module 112 determines the first candidate resource set S_{A-LTE}. In turn, the NR sidelink module 112 selects the at least one PSSCH resource for transmitting the first sidelink data based on the first candidate resource set S_{A-LTE}.

As shown in FIG. 9, the NR sidelink module 112 determines 910 the first sidelink data to be transmitted which may use the first type of sidelink resources (for example, shared resources).

In turn, the NR sidelink module 112 provides the request for the assistant information to the LTE sidelink module 111.

In some embodiments, the NR sidelink module 112 may provide the request for the assistant information by providing 920 a trigger indication.

The NR sidelink module 112 performs 930 NR mode 2 sensing and resource selection procedure on NR sidelink to determine the second candidate resource set S_{A-NR}.

On the side of the LTE sidelink module 111, upon receiving the trigger indication, the LTE sidelink module 111 performs 940 the following actions on LTE sidelink to determine the assistant information:
sensing and SCI decoding within a sensing window on LTE sidelink or within the first type of sidelink resources; and
PSCCH RSRP or PSSCH RSRP measurement associated with decoded SCI.

In such embodiments, the assistant information may comprise at least one of the following:
subframes on which no sensing was performed by the LTE sidelink module 111,
SCI decoded by the LTE sidelink module 111 within the first type of sidelink resources,
a subframe location of each of the SCI,
a PSCCH resource associated with each of the SCI,
an RSRP on a PSSCH resource associated with each of the SCI, or
an RSRP on a PSCCH resource associated with each of the SCI.

In such embodiments, contents and format of the assistant information to be determined by LTE sidelink module 111 may be predefined.

Upon determining the assistant information, the LTE sidelink module 111 provides 950 the assistant information to the NR sidelink module 112.

Upon receiving the assistant information, the NR sidelink module 112 determines 960 the first candidate resource set S_{A-LTE} based on the assistant information.

In some embodiments, in order to determine the first candidate resource set S_{A-LTE}, the NR sidelink module 112 may set an initial candidate resource set as all resources within shared resources. Then, the NR sidelink module 112 may exclude, from the initial candidate resource set, the resources on subframes on which no sensing was performed by the LTE sidelink module 111. In addition, according to decoded SCI, the NR sidelink module 112 may exclude associated PSSCH resource when following conditions are all achieved:
RSRP of the PSSCH is higher than a threshold determined according to the priority indicated in the SCI and priority of the data to be transmitted:
reserved PSSCH resource associated with the SCI, including periodic reservation and reservation for retransmission.

Then, the NR sidelink module 112 determines 970 the candidate resource set S_{A} as a combination of the second candidate resource set S_{A-NR} and the first candidate resource set S_{A-LTE}. In turn, the NR sidelink module 112 selects 980 the at least one PSSCH resource for transmitting the first sidelink data based on the candidate resource set S_{A}. For example, the NR sidelink module 112 may select the at least one PSSCH resource within the shared resources, i.e, within the first candidate resource set S_{A-LTE}. For another example, the NR sidelink module 112 may select the at least one PSSCH resource within the second candidate resource set S_{A-NR}.

In other embodiments, the NR sidelink module 112 may not determine the candidate resource set S_{A} as the combination of the second candidate resource set S_{A-NR} and the first candidate resource set S_{A-LTE}. Instead, the NR sidelink module 112 may determine the candidate resource set S_{A} as the first candidate resource set S_{A-LTE}.

The process 900 may have limited impact on LTE mode 4 procedure and less requirement and workload of LTE SL module. The assistant information is obtained by NR SL module and resource selection is determined accordingly which may provide more suitable resources for sidelink co-existence scenario.

In some embodiments, the first terminal device 110 may only comprise the second module of the second sidelink. In such embodiments, the first terminal device 110 may be referred to as Type B sidelink terminal device or UE 110.

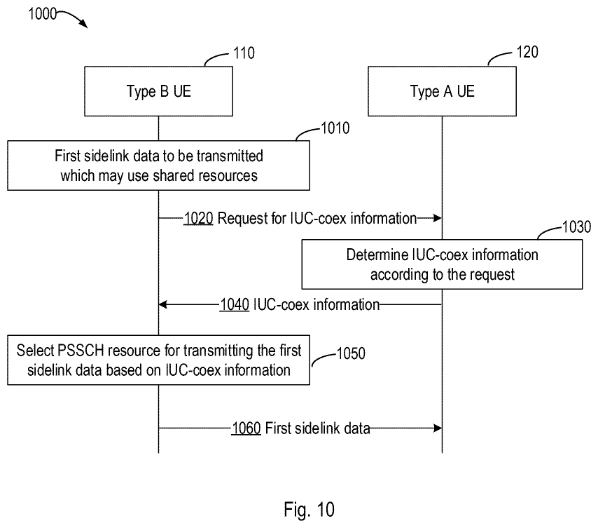

In some embodiments, the first terminal device 110 may receive the assistant information from the second terminal device 120. In such embodiments, the second terminal device 120 comprises the first module of the first sidelink and the second module of the second sidelink. This will be described with reference to FIGS. 10 to 14.

FIG. 10 illustrates a signaling chart illustrating a process 1000 for selecting at least one PSSCH resource in accordance with some implementations of the present disclosure. For the purpose of discussion, the process 1000 will be described with reference to FIG. 1. The process 1000 may involve the first terminal device 110 and the second terminal device 120 as illustrated in FIG. 1. Although the process 1000 will be described in the communication network 100 of FIG. 1, this process may be likewise applied to other communication scenarios.

In the process 1000, the first terminal device 110 only comprises the second module of the second sidelink (for example, an NR sidelink module). The second terminal device 120 comprises the first module of the first sidelink (for example, an LTE sidelink module) and the second module of the second sidelink (for example, an NR sidelink module). In this regard, the first terminal device 110 and the second terminal device 120 are also referred to as Type B UE 110 and Type A UE 120.

As shown in FIG. 10, the first terminal device 110 determines 1010 the first sidelink data to be transmitted which may use the first type of sidelink resources (for example, shared resources).

In turn, the first terminal device 110 transmits a request for the assistant information to the second terminal device 120.

In some embodiments, the first terminal device 110 may transmit the request for the assistant information by transmitting 1020 a request for inter UE coordination information for co-existence (IUC-coex) information.

In some embodiments, the IUC-coex information may comprise at least one of the following:
a preferred resource set for the transmission of the first sidelink data within the first type of sidelink resources,
a non-preferred resource set for the transmission of the first sidelink data within the first type of sidelink resources, or
an indication of potential conflict between a first reserved resource for transmission of the first sidelink data and a second reserved resource for transmission of a third terminal device within the first type of sidelink resources.

Upon receiving the request for the IUC-coex information, the second terminal device 120 determines 1030 the IUC-coex information based on the request.

Then, the second terminal device 120 transmits 1040 the IUC-coex information to the first terminal device 110. In embodiments where the first terminal device 110 transmits the request for the assistant information by transmitting 1020 the request for the IUC-coex information, the second terminal device 120 transmitting to the first terminal device 110 a response to the request for the assistant information. The response comprises the IUC-coex information.

Upon receiving the IUC-coex information, the first terminal device 110 selects 1050 the at least one PSSCH resource for transmitting the first sidelink data based on IUC-coex information.

Then, the first terminal device 110 transmits 1060 the first sidelink data to the second terminal device 120 on the selected at least one PSSCH resource.

With the process 1000, mode 2 IUC schemes are modified to enable Type B UE to use shared resources for sidelink communication. The process 1000 introduces less impact on legacy NR mode 2 sensing and resource selection procedure.

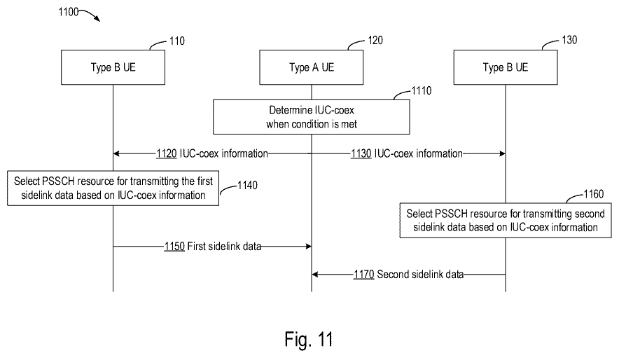

FIG. 11 illustrates a signaling chart illustrating a process 1100 for selecting at least one PSSCH resource in accordance with some other implementations of the present disclosure. For the purpose of discussion, the process 1100 will be described with reference to FIG. 1. The process 1100 may involve the first terminal device 110, the second terminal device 120 and the third terminal device 130 as illustrated in FIG. 1. Although the process 1100 will be described in the communication network 100 of FIG. 1, this process may be likewise applied to other communication scenarios.

In the process 1100, each of the first terminal device 110 and third terminal device 130 only comprises the second module of the second sidelink (for example, an NR sidelink module). In this regard, the first terminal device 110 and third terminal device 130 are also referred to as Type B UE 110 and Type B UE 130.

The second terminal device 120 comprises the first module of the first sidelink (for example, an LTE sidelink module) and the second module of the second sidelink (for example, an NR sidelink module). In this regard, the second terminal device 120 is also referred to as Type A UE 120

The process 1100 is different from the process 1000 in that the second terminal device 120 does not determine the IUC-coex information based on the request for the IUC-coex information. Instead, when the second terminal device 120 determines that at least one predefined condition is met, the second terminal device 120 determines 1110 the IUC-coex information.

In some embodiments, the predefined condition may be determined according to pre-configuration of configuration of IUC-coex information which includes at least one of the following:
up to the second terminal device 120 implementation to determine whether and when to send the IUC-coex information,
when the second terminal device 120 has sidelink data to be transmitted to the first terminal device 110 and/or the third terminal device 130; or
according to pre-configured or configured requirement information of a sidelink data packet, preferred or non-preferred resource set associated with the sidelink data packet can be determined.

In turn, the second terminal device 120 transmits 1120 the IUC-coex information to the first terminal device 110. In addition, the second terminal device 120 transmits 1130 the IUC-coex information to the third terminal device 130.

In some embodiments, the second terminal device 120 transmits the IUC-coex information using sidelink groupcast or broadcast. For example, the second terminal device 120 transmits the IUC-coex information to the first terminal device 110, and transmits 1130 the IUC-coex information to the third terminal device 130, while the transmissions 120 and 130 are the same signaling.

In some embodiments, the IUC-coex information may comprise at least one of the following:
a preferred resource set for the transmission of the first sidelink data within the first type of sidelink resources,
a non-preferred resource set for the transmission of the first sidelink data within the first type of sidelink resources, or
an indication of potential conflict between a first reserved resource for transmission of the first sidelink data and a second reserved resource for transmission of a third terminal device within the first type of sidelink resources.

Upon receiving the IUC-coex information, the first terminal device 110 selects 1140 the at least one PSSCH resource for transmitting the first sidelink data based on IUC-coex information.

Then, the first terminal device 110 transmits 1150 the first sidelink data to the second terminal device 120 on the selected at least one PSSCH resource.

In some embodiments, the first terminal device 110 transmits the first sidelink data on the selected at least one PSSCH resource by using sidelink groupcast or broadcast.

On the side of the third terminal device 130, upon receiving the IUC-coex information, the third terminal device 130 selects 1160 at least one PSSCH resource for transmitting second sidelink data based on IUC-coex information.

Then, the third terminal device 130 transmits 1170 the second sidelink data to the second terminal device 120 on the selected at least one PSSCH resource.

In some embodiments, the first terminal device 130 transmits the second sidelink data on the selected at least one PSSCH resource by using sidelink groupcast or broadcast.

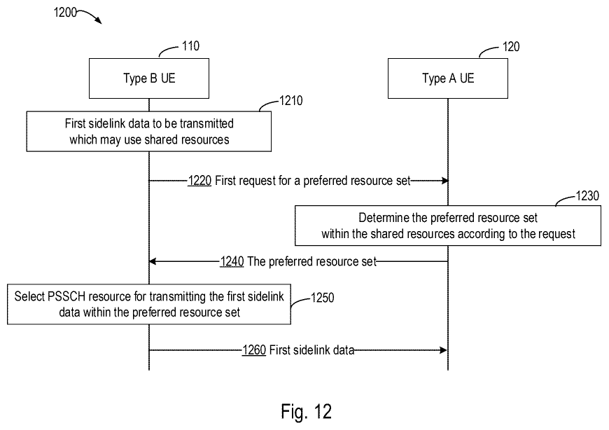

As described with reference to FIG. 10, in some embodiments, the IUC-coex information may comprise the preferred resource set for the transmission of the first sidelink data within the first type of sidelink resources. In such embodiments, the first terminal device 110 may transmit the request for the assistant information by transmitting a first request for the preferred resource set for the transmission of first sidelink data. This will be described with reference to FIG. 12.

FIG. 12 illustrates a signaling chart illustrating a process 1200 for selecting at least one PSSCH resource in accordance with some implementations of the present disclosure. For the purpose of discussion, the process 1200 will be described with reference to FIG. 1. The process 1200 may involve the first terminal device 110 and the second terminal device 120 as illustrated in FIG. 1. The process 1200 may be considered as an example implementation of the process 1000. Although the process 1200 will be described in the communication network 100 of FIG. 1, this process may be likewise applied to other communication scenarios.

In the process 1200, the first terminal device 110 and the second terminal device 120 are sidelink unicast UE pair, i.e., PC5 RRC connected.

As shown in FIG. 12, the first terminal device 110 determines 1210 the first sidelink data to be transmitted which may use the first type of sidelink resources (for example, shared resources).

In turn, the first terminal device 110 transmits 1220 a first request for a preferred resource set for the transmission of first sidelink data. The first request may comprise at least one of the following:
a priority of the first sidelink data,
a period of the first sidelink data,
a resource selection window for the at least one PSSCH resource, or.
the number of sub-channels or resource blocks to be selected for the transmission of the first sidelink data.

In some embodiments, the first terminal device 110 may transmit the first request for the preferred resource set in an MAC CE.

In some embodiments, the first terminal device 110 may determine the resource selection window based on a subcarrier spacing of the first type of sidelink resources.

In some embodiments, the first terminal device 110 may determine the number of sub-channels or resource blocks based on the configuration of the first type of sidelink resources.

Upon receiving the first request for the preferred resource set, the second terminal device 120 determines 1230 the preferred resource set within the shared resources according to the first request. For example, the second terminal device 120 may determine the preferred resource set by its NR sidelink module as done by the NR sidelink module 112 in FIGS. 8 and 9.

Then, the second terminal device 120 transmits 1240 the preferred resource set to the first terminal device 110.

Upon receiving the preferred resource set, the first terminal device 110 selects 1250 the at least one PSSCH resource for transmitting the first sidelink data within the preferred resource set.

Then, the first terminal device 110 transmits 1260 the first sidelink data to the second terminal device 120 on the selected at least one PSSCH resource.

The process 1200 provides more suitable preferred resource set for Type B UE according to its requirement.

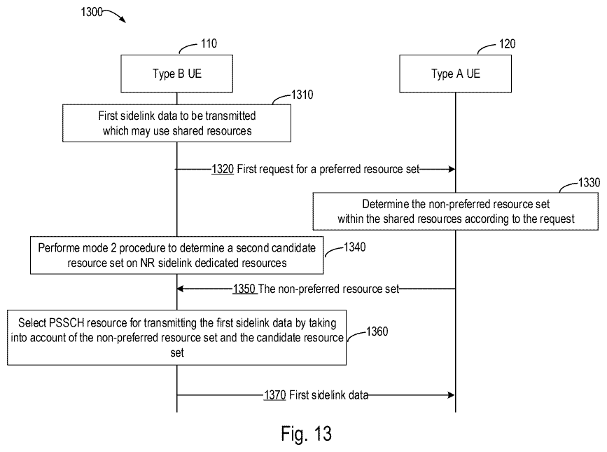

As described with reference to FIG. 10, in some embodiments, the IUC-coex information may comprise the non-preferred resource set for the transmission of the first sidelink data within the first type of sidelink resources. In such embodiments, the first terminal device 110 may transmit the request for the assistant information by transmitting a second request for the non-preferred resource set for the transmission of first sidelink data. This will be described with reference to FIG. 13.

FIG. 13 illustrates a signaling chart illustrating a process 1300 for selecting at least one PSSCH resource in accordance with some implementations of the present disclosure. For the purpose of discussion, the process 1300 will be described with reference to FIG. 1. The process 1300 may involve the first terminal device 110 and the second terminal device 120 as illustrated in FIG. 1. The process 1300 may be considered as a further example implementation of the process 1000. Although the process 1300 will be described in the communication network 100 of FIG. 1, this process may be likewise applied to other communication scenarios.

In the process 1300, the second terminal device 120 is a destination terminal device of a TB (data packet) to be transmitted by the first terminal device 110, or the second terminal device 120 received SCI of the first terminal device 110 which reserved resources within the shared resources.

As shown in FIG. 13, the first terminal device 110 determines 1310 the first sidelink data to be transmitted which may use the first type of sidelink resources (for example, shared resources).

In turn, the first terminal device 110 transmits 1320 a second request for a non-preferred resource set for the transmission of first sidelink data. For example, the first terminal device 110 may transmit the second request in SCI. The SCI may indicate reserved resources in the shared resources.

Upon receiving the second request for the non-preferred resource set, the second terminal device 120 determines 1330 the non-preferred resource set. The non-preferred resource set comprises one or more resources within the shared resources. For example, the non-preferred resource set may comprise at least one of the following:
a resource on a slot or a subframe that the second terminal device 120 does not receive for sidelink signal,
a first reserved resource for transmission of the first sidelink data which conflicts with a second reserved resource for transmission of a third terminal device, or
a resource with an RSRP exceeding an RSRP threshold for the first type of sidelink resources,
   wherein the RSRP exceeding an RSRP threshold includes at least one of the following:
      the RSRP is equal to or higher than an RSRP threshold;
      the second terminal device 120 is a target receiving device of the first sidelink data, and the RSRP is equal to or lower than another RSRP threshold.

On the side of the first terminal device 110, the first terminal device 110 performs 1340 NR mode 2 sensing and resource selection procedure to determine a second candidate resource set on NR sidelink dedicated resources.

Upon determining the non-preferred resource set, the second terminal device 120) transmits 1350 the non-preferred resource set to the first terminal device 110.

Upon receiving the non-preferred resource set, the first terminal device 110 selects 1360 the at least one PSSCH resource for transmitting the first sidelink data by taking into account of the non-preferred resource set and the second candidate resource set.

Then, the first terminal device 110 transmits 1370 the first sidelink data to the second terminal device 120 on the selected at least one PSSCH resource.

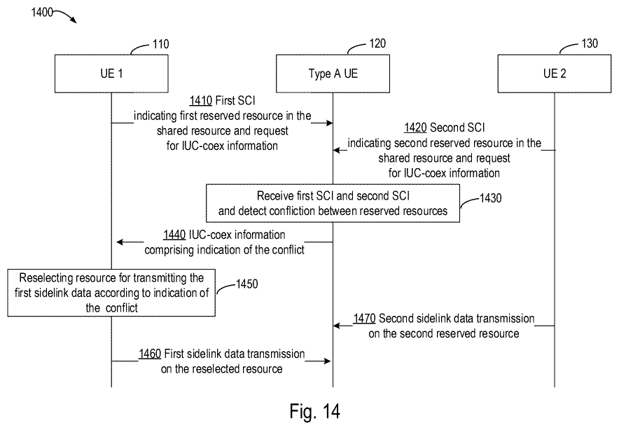

As described with reference to FIG. 10, in some embodiments, the IUC-coex information may comprise the indication of potential conflict between a first reserved resource for transmission of the first sidelink data and a second reserved resource for transmission of a third terminal device within the first type of sidelink resources. In such embodiments, the first terminal device 110 may transmit the request for the assistant information by transmitting a third request for the indication of potential conflict. This will be described with reference to FIG. 14.

FIG. 14 illustrates a signaling chart illustrating a process 1400 for selecting at least one PSSCH resource in accordance with some implementations of the present disclosure. For the purpose of discussion, the process 1400 will be described with reference to FIG. 1. The process 1400 may involve the first terminal device 110, the second terminal device 120 and the third terminal device 130 as illustrated in FIG. 1. The process 1400 may be considered as an example implementation of the process 1100. Although the process 1400 will be described in the communication network 100 of FIG. 1, this process may be likewise applied to other communication scenarios.

In the process 1400, each of the first terminal device 110 and the third terminal device 130 may be a Type A UE or Type B UE. In this regard, the first terminal device 110 and the third terminal device 130 are also referred to as UE 110 and UE 130, respectively. In addition, the second terminal device 120 may be a Type A UE. In this regard, the second terminal device 120 referred to as Type A UE 120. In addition, the third terminal device 130 may be a device with only LTE sidelink module, e.g., a LTE UE with sidelink function.

As shown in FIG. 14, the first terminal device 110 transmits 1410 first SCI to the second terminal device 120. The first SCI indicates a first reserved resource in the shared resources. The first reserved resource may be used for transmission of the first sidelink data. The first SCI also indicates the third request for the indication of potential conflict.

Similarly, the third terminal device 130 transmits 1420 second SCI to the second terminal device 120. The second SCI indicates a second reserved resource in the shared resources. The second reserved resource may be used for transmission of second sidelink data.

It should be understood that although the actions 1410 and 1420 are shown in sequence, in some embodiments, the actions 1410 and 1420 may be performed in parallel. Alternatively, the action 1420 may be performed before the action 1410.

On the side of the second terminal device 120, the second terminal device 120 receives 1430 the first SCI and the second SCI and detects potential conflict between the first reserved resource and the second reserved resource.

When the second terminal device 120 determines that at least one predefined condition is met, the second terminal device 120 transmits the IUC-coex information to at least one of the first terminal device 110 and the third terminal device 130. The IUC-coex information comprises the indication of the potential conflict. In some embodiments, the second terminal device 120 transmits the IUC-coex information to a terminal device with lower priority in the associated SCI. For example, if a priority in the first SCI transmitted by the first terminal device 110 is lower than a priority in the second SCI transmitted by the third terminal device 130, the second terminal device 120 transmits 1440 the IUC-coex information to the first terminal device 110.

Upon receiving the IUC-coex information which comprises the indication of the potential conflict, the first terminal device 110 reselects 1450 resources according to the indication of the potential conflict for transmitting the first sidelink data.

Then, the first terminal device 110 transmits 1460 the first sidelink data to the second terminal device 120 on the reselected resources.

On the side of the third terminal device 130, since the third terminal device 130 does not receive the indication of the potential conflict, the third terminal device 130 transmits 1470 the second sidelink data to the second terminal device 120 on the second reserved resource.

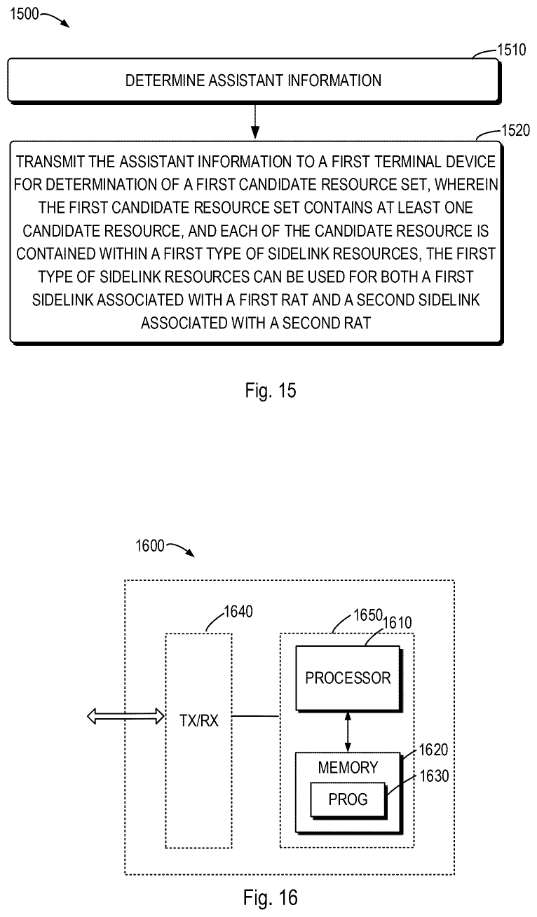

FIG. 15 illustrates a flowchart of an example method in accordance with some embodiments of the present disclosure. In some embodiments, the method 1500 can be implemented at a terminal device, such as one of the first terminal device 110, the second terminal device 120 and the third terminal device 130 as shown in FIG. 1. For the purpose of discussion, the method 1500 will be described with reference to FIG. 1 as performed by the second terminal device 120 without loss of generality.

At block 1510, the second terminal device 120 determines assistant information.

At block 1520, the second terminal device 120 transmits the assistant information to the first terminal device 110 for determination of a first candidate resource set. The first candidate resource set contains at least one candidate resource, and each of the candidate resource is contained within a first type of sidelink resources, the first type of sidelink resources can be used for both a first sidelink associated with a first RAT and a second sidelink associated with a second RAT.

In some embodiments, the second terminal device 120 comprises a first module of the first sidelink and a second module of the second sidelink.

In some embodiments, the assistant information comprises at least one of the following:
a preferred resource set within the first type of sidelink resources, the preferred resource set being for transmission of first sidelink data by the first terminal device 110,
a non-preferred resource set for the transmission of the first sidelink data within the first type of sidelink resources, or
an indication of potential conflict between a first reserved resource for transmission of the first sidelink data and a second reserved resource for transmission of a third terminal device within the first type of sidelink resources.

In some embodiments, the method 1500 further comprises: receiving a request for the assistant information from the first terminal device 110. In such embodiments, transmitting the assistant information comprises: transmitting a response to the request, the response comprising the assistant information.

In some embodiments, receiving the request for the assistant information comprises: receiving a first request for a preferred resource set for the transmission of first sidelink data. The first request comprises at least one of the following:
a priority of the first sidelink data,
a period of the first sidelink data,
a resource selection window for the at least one PSSCH resource, or
the number of sub-channels or resource blocks to be selected for the transmission of the first sidelink data.

In some embodiments, the resource selection window is determined based on a subcarrier spacing of the first type of sidelink resources.

In some embodiments, the number of sub-channels or resource blocks is determined based on a configuration of the first type of sidelink resources.

In some embodiments, receiving the request for the assistant information comprises: receiving a second request for a non-preferred resource set for the transmission of first sidelink data within the first type of sidelink resources.

In some embodiments, the response comprises the non-preferred resource set, the non-preferred resource set comprising at least one of the following:
a resource on a slot or a subframe that the second terminal device 120 does not receive for sidelink signal,
a first reserved resource for transmission of the first sidelink data which conflicts with a second reserved resource for transmission of a third terminal device, or
a resource with a Reference Signal Receiving Power (RSRP) exceeding an RSRP threshold for the first type of sidelink resources.

In some embodiments, transmitting the assistant information comprises: transmitting the assistant information if at least one predefined condition is met.

FIG. 16 is a simplified block diagram of a device 1600 that is suitable for implementing some embodiments of the present disclosure. The device 1600 can be considered as a further example embodiment of one of the terminal devices 110, 120 and 130, or one of the network devices 140 and 150 as shown in FIG. 1. Accordingly, the device 1600 can be implemented at or as at least a part of one of the terminal devices 110, 120 and 130, or one of the network devices 140 and 150.

As shown, the device 1600 includes a processor 1610, a memory 1620 coupled to the processor 1610, a suitable transmitter (TX) and receiver (RX) 1640 coupled to the processor 1610, and a communication interface coupled to the TX/RX 1640. The memory 1620 stores at least a part of a program 1630. The TX/RX 1640 is for bidirectional communications. The TX/RX 1640 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1630 is assumed to include program instructions that, when executed by the associated processor 1610, enable the device 1600 to operate in accordance with the embodiments of the present disclosure, as discussed herein with reference to FIGS. 1 to 15. The embodiments herein may be implemented by computer software executable by the processor 1610 of the device 1600, or by hardware, or by a combination of software and hardware. The processor 1610 may be configured to implement various embodiments of the present disclosure. Furthermore, a combination of the processor 1610 and memory 1620 may form processing means 1650 adapted to implement various embodiments of the present disclosure.

The memory 1620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1620 is shown in the device 1600, there may be several physically distinct memory modules in the device 1600. The processor 1610 may be of any type suitable to the local technical network, and may include one or more of general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs). Application-specific Integrated Circuits (ASICs). Application-specific Standard Products (ASSPs). System-on-a-chip systems (SOCs). Complex Programmable Logic Devices (CPLDs), and the like.

1-20. (canceled)

21. A method performed by a terminal device, comprising:
receiving a configuration information comprising a list of reference signal receiving power (RSRP) thresholds for coexistence of a first sidelink associated with a first radio access technology (RAT) and a second sidelink associated with a second RAT;
determining a subset of resources for a physical sidelink shared channel (PSSCH) transmission; and
transmitting the PSSCH transmission on resources from the subset of resources,
wherein determining the subset of resources for the PSSCH transmission comprising:
setting an initial candidate resource set, resources in the initial candidate resource set being resources that are shared between the first sidelink associated with the first RAT and the second sidelink associated with the second RAT; and
excluding a resource(s) from the initial candidate resource set based on information for subframes of the first RAT, the information being known to the second RAT,
wherein excluding the resource(s) from the initial candidate resource set comprising:
excluding a resource(s) associated with a subframe of the first RAT that the terminal device has not monitored; and
excluding, a resource(s), based on RSRP of a PSSCH according to a received sidelink control information (SCI) associated with the first RAT being higher than a RSRP threshold and reserved resource(s) associated with the received SCI,
wherein the RSRP threshold is selected from the list based on a priority in the received SCI associated with the first RAT and a priority in a SCI associated with the second RAT to be transmitted.

22. The method of claim 21, wherein the first RAT is long term evolution (LTE), and the second RAT is new radio (NR).

23. A terminal device, comprising a processor configured to:
receiving a configuration information comprising a list of reference signal receiving power (RSRP) thresholds for coexistence of a first sidelink associated with a first radio access technology (RAT) and a second sidelink associated with a second RAT;
determining a subset of resources for a physical sidelink shared channel (PSSCH) transmission; and
transmitting the PSSCH transmission on resources from the subset of resources,
wherein determining the subset of resources for the PSSCH transmission comprising:
setting an initial candidate resource set, resources in the initial candidate resource set being resources that are shared between the first sidelink associated with the first RAT and the second sidelink associated with the second RAT; and
excluding a resource(s) from the initial candidate resource set based on information for subframes of the first RAT, the information being known to the second RAT,
wherein excluding the resource(s) from the initial candidate resource set comprising:
excluding a resource(s) associated with a subframe of the first RAT that the terminal device has not monitored; and
excluding, a resource(s), based on RSRP of a PSSCH according to a received sidelink control information (SCI) associated with the first RAT being higher than a RSRP threshold and reserved resource(s) associated with the received SCI,
wherein the RSRP threshold is selected from the list based on a priority in the received SCI associated with the first RAT and a priority in a SCI associated with the second RAT to be transmitted.

24. The terminal device of claim 23, wherein the first RAT is long term evolution (LTE), and the second RAT is new radio (NR).
